(19) United States
(12) Patent Application Publication
(10) Pub. No.: US 2026/0313295 A1
(43) Pub. Date: Oct. 8, 2026

(54) SOUND LEVEL METHOD AND MANAGER, SOUND REPRODUCTION DEVICE AND AUDIO HEADSET USING SAME

(71) Applicant: ORANGE, Issy-les-Moulineaux (FR)

(72) Inventors: Christian GREGOIRE, CHATILLON (FR); Cyril PLAPOUS, CHATILLON (FR)

(21) Appl. No.: 19/481,310

(22) PCT Filed: May 6, 2024
(86) PCT No.: PCT/EP2024/062379

§ 371 Date: Nov. 4, 2025

(30) Foreign Application Priority Data
May 5, 2023 (FR) FR2304515

(51) Int. Cl. H04R 5/04; H04R 5/033

(52) U.S. Cl. CPC H04R 5/04; H04R 5/033; H04R 2430/01

(57) ABSTRACT

A sound level method and manager for managing a sound level during reproduction of a sound signal, to a sound reproduction device and to an audio headset using same. The method includes generating a management signal for managing the sound reproduction as a function of at least one parameter of a neural signal relating to auditory tolerance picked up during listening to the reproduced sound signal. Thus, it is possible to automatically manage the sound level: either by adjusting it automatically or by signaling to the user that the sound level is not appropriate (in particular too high) based on the feeling of the user's brain. The user's brain is capable of detecting that the sound level is not appropriate even when the user themselves seems to be enjoying the current sound level.

### CROSS-REFERENCE TO RELATED APPLICATIONS

This Application is a Section 371 National Stage Application of International Application No. PCT/EP2024/062379, filed May 6, 2024, and published as WO 2024/231321 A1 on Nov. 14, 2024, not in English, which claims priority to and the benefit of French Patent Application No. FR2304515, filed May 5, 2023, the contents of which are incorporated herein by reference in their entireties.

### TECHNICAL FIELD

The invention relates to a sound level method and manager for managing a sound level during reproduction of a sound signal, to a sound reproduction device and to an audio headset using same.

### PRIOR ART

Nowadays, more and more people, in particular young people, listen to music through audio headsets. The WHO warns that 53% of young people listen to their music with sound levels that are excessively high and dangerous for their hearing, as indicated in the article by the Science-Presse Agency “Ecouteurs: l'ouïe des jeunes plus à risque ? Vrai” [Earphones: the hearing of young people more at risk? True] (https://www.scientifique-en-chef.gouv.qc.ca/impacts/ddr_ecouteurs-louie-des-jeunes-plus-a-risque-vrai/). The same study points out that more and more young people and adults are thus suffering from hearing damage as a result of the incorrect use of audio headsets. This damage is very often irreversible, and so it is necessary to emphasize preventing these problems and acting in advance.

When listening to a headset, it may be necessary to increase the sound due to ambient noise, for example in public transport. The sound level of music or communication is then increased, and becomes dangerous to health without realizing. Other people enjoy their music with a loud level, without being aware of the risks to their hearing. Indeed, excessively high sound levels may damage hearing without the user realizing. There is generally no pain or warning sign. The first signs (for example tinnitus) appear when it is already too late.

### DISCLOSURE OF THE INVENTION

One of the aims of the present invention is to rectify some drawbacks/deficiencies of the prior art/to make improvements to the prior art.

One subject of the invention is a management method for managing a sound level during sound reproduction of a sound signal, the management method comprising:
generating a management signal for managing the sound level of the sound reproduction of the sound signal as a function of at least one parameter of a picked-up neural signal, the neural signal being picked up on the basis of listening to the sound reproduction of the sound signal.

The invention thus makes it possible to automatically manage the sound level: either by adjusting it automatically or by signaling to the user that the sound level is not appropriate (in particular too high) based on the feeling of the user's brain. Indeed, the user's brain is capable of detecting that the sound level is not appropriate even when the user themselves seems to be enjoying the current sound level. Therefore, the parameter of the neural signal picked up on the basis of listening to the reproduced sound signal makes it possible to determine that the sound level is inappropriate for the auditory system of a particular user.

Advantageously, the management method comprises:
triggering generation as soon as the value of the parameter of the picked-up neural signal crosses predetermined threshold value.

The management of the sound level is thus immediate and does not leave time for ear lesions to set in, in particular in the event of very loud sound signals, for example sound signals of more than 100 dB, for which damage may occur after just 15 minutes.

Advantageously, the threshold value is one of the following values:
a maximum alert value;
a maximum tolerance value;
a minimum value.

It is thus possible to envisage various management actions depending on the type of threshold value. For example, the alert value in particular triggers an indication to the user that this first threshold has been crossed, and the tolerance value triggers automatic lowering of the sound level until the detected neural signal returns to a range of normal values.

Advantageously, triggering generation depends on the user sound reproduction context.

The management of the sound level thus takes into account not only the sound level, also called the sound volume, but also the listening context, that is to say in particular the listening time and/or the listening frequency. For example, the threshold values may depend on the usage context. In particular, for a context corresponding to long-term and/or frequent listening, the maximum tolerance value will be lower than for a context of short-term and/or rare listening. For example, in a user context such as listening in an outdoor urban environment, in particular in the street, the sound level will be automatically adjusted so that the user retains attention in relation to their context (in particular to the vehicles around them).

Advantageously, the at least one parameter of the neural signal comprises at least one of the following parameters:
a parameter of the beta wave of the neural signal;
a parameter of the alpha wave of the neural signal;
an absolute power of a wave of the neural signal.

The use of the beta wave thus makes it possible to detect, based on the value of the parameter of the beta wave, that the user listening to the reproduction of the sound signal is simply focused, thereby indicating listening with an appropriate sound level (in particular a sound level that is too high, or even aggressive for the user's hearing) or that the user is anxious, thereby indicating an inappropriate sound level, or even several stages of inappropriateness of the sound level with the user's hearing.

The use of the alpha wave thus makes it possible to detect, based on the value of the parameter of the alpha wave, that the user listening to the reproduction of the sound signal is relaxed or alert, thereby indicating listening with an appropriate sound level. In particular, the detection of a reduction in the alpha wave makes it possible to detect a variation in the sound level toward an inappropriate level. The use of absolute power thus enables better detection of alpha and beta waves, and therefore better management of the sound level.

Advantageously, the sound level management signal comprises at least one of the following signals:
an indicator signal;
a control signal for controlling the sound reproduction device reproducing the sound signal.

The indicator signal thus makes it possible to signal, to the user, an inappropriate sound level, giving them the option to act thereon or not. The user is then aware of the risk they are taking for their hearing. And the control signal makes it possible to automatically adjust the sound level to protect the user's hearing.

These two types of signal may be used:
either alone, for example for distinct thresholds, or at the choice of the user, who prefers to retain control of the reproduction sound level (indicator signal) or automatically protect their hearing (control signal);
or in combination; thus, when the automatic adjustment is implemented, the user is informed at the same time of the reason for this automatic adjustment by the indicator signal.

Advantageously, the management method comprises:
controlling a variation of the sound level based on a variation of the parameter of the picked-up neural signal.

Advantageously, the direction of controlled variation of the sound level is at least one of the following directions:
a direction identical to the direction of variation of the parameter of the beta wave of the neural signal;
a direction opposite the direction of variation of the parameter of the alpha wave of the neural signal.

Advantageously, wherein the indicator signal is at least one of the following indicators:
a visual indicator;
an onomatopoeic acoustic indicator;
an audible alarm acoustic indicator;
an audio message acoustic indicator.

Advantageously, the management method comprises one of the following steps:
replacing, in the signal to be reproduced, the sound signal with an acoustic indicator signal;
mixing the acoustic indicator signal with the sound signal, the mixed sound signal constituting the signal to be reproduced.

The replacement thus enables better hearing of the acoustic indicator since it is reproduced on its own, especially if it contains an audio message. And the mixing makes it possible to continue listening to the sound signal during the acoustic indication of the inappropriate sound level.

Advantageously, according to one implementation of the invention, the various steps of the method according to the invention are implemented by software or a computer program, this software comprising software instructions intended to be executed by a data processor of a sound level manager in particular forming part of a sound reproduction device and/or of an audio headset and being designed to control the execution of the various steps of this method.

The invention therefore also targets a program comprising program code instructions for executing the steps of the management method according to the invention when said program is executed by a processor.

This program may use any programming language and be in the form of source code, object code or intermediate code between source code and object code, such as in a partially compiled form or in any other desirable form.

Another subject of the invention is a manager for managing a sound level during reproduction of a sound signal, the manager comprising:
a generator for generating a management signal for managing the sound level of a sound reproduction of a sound signal as a function of at least one parameter of a neural signal picked up on the basis of listening to the reproduced sound signal.

Another subject of the invention is a sound reproduction device capable of reproducing a signal to be reproduced comprising a sound signal, the reproduction device comprising:
an actuator capable of being managed based on a management signal for managing the sound level of a sound reproduction of a sound signal as a function of at least one parameter of a neural signal picked up on the basis of listening to the reproduced sound signal by a direct neural interface collocated with the sound reproduction device.

Advantageously, the actuator comprises at least one of the following following actuators:
a display capable of being controlled based on the sound level management signal;
a display capable of reproducing a message contained in the sound level management signal;
a sound level controller capable of being controlled based on the sound level management signal;
a switch capable of replacing, in a signal to be reproduced, a sound signal with the sound level management signal;
a mixer capable of mixing the sound signal and the sound level management signal, the mixed sound signal constituting the signal to be reproduced.

Advantageously, an audio headset comprises:
a sound level manager according to the invention;
a sound reproduction device according to the invention, and
a direct neural interface capable of picking up the neural signal during listening to the reproduced sound signal.

The equipment worn by the user to listen to sound content thus protects their hearing in a personalized manner and without additional equipment.

### BRIEF DESCRIPTION OF THE DRAWINGS

The features and advantages of the invention will become more clearly apparent on reading the description, which is given by way of example, and the related figures, in which:

FIG. 1 shows a simplified diagram of a management method according to the invention;

FIG. 2a shows a simplified diagram of a manager according to the invention;

FIG. 2b shows a simplified diagram of a sound reproduction device according to the invention;

FIG. 2c shows a simplified diagram of an audio headset according to the invention;

FIG. 3 shows a simplified diagram of picked-up neural signals and reproduced sound signals according to the invention.

### DESCRIPTION OF EMBODIMENTS

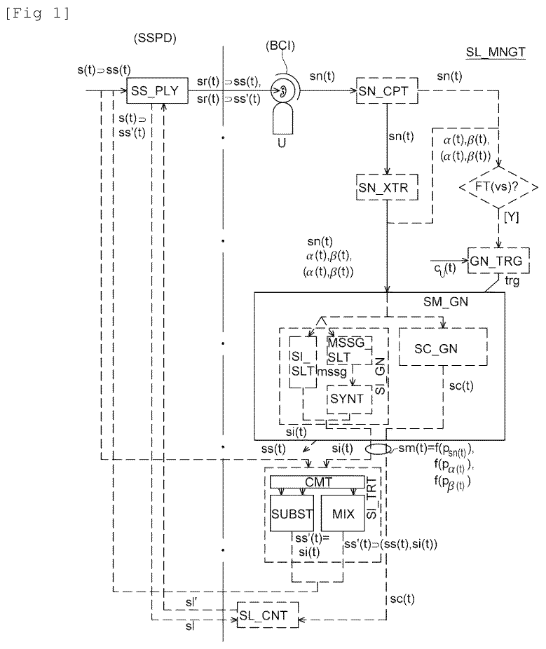

FIG. 1 illustrates a simplified diagram of a management method according to the invention.

The management method SL_MNGT manages the sound level sl during reproduction SS_PLY of a sound signal ss(t). The management method SL_MNGT comprises:
generating SM_GN a management signal sm(t) for managing the sound level of a sound reproduction of a sound signal, also called management signal, as a function of at least one parameter pₛₙ₍ₜ₎ of a neural signal sn(t) picked up on the basis of listening to the reproduced sound signal sr(t).

In particular, the management method SL_MNGT comprises:
triggering GN_TRG generation SM_GN as soon as the value of the parameter of the picked-up neural signal sn(t) crosses a predetermined threshold value vs.

A threshold value is understood to mean a value related to auditory tolerance, such as a start of intolerance value or an ultimate intolerance value.

In particular, the threshold value vs is one of the following values:
a maximum alert value vaₘₐₓ;
a maximum tolerance value vtₘₐₓ;
a minimum value vsₘᵢₙ;
etc.

For example, the maximum alert value is a low start of intolerance or discomfort value that may lead to long-term damage to the auditory system; the maximum tolerance value is an ultimate intolerance value or a value beyond which the risk of hearing damage is irreversible; a minimum value is a low/moderate or maximum intolerance or discomfort value that may lead to attention and listening problems.

In particular, triggering generation GN_TRG depends on the user sound reproduction context cᵤ(t).

In particular, the at least one parameter pₛₙ₍ₜ₎ of the neural signal comprises at least one of the following parameters:
a parameter of the beta wave of the neural signal p_{β(t)};
a parameter of the alpha wave of the neural signal p_{α(t)};
an absolute power of a wave of the neural signal paₒ₍ₜ₎.

In particular, the management signal sm(t) comprises at least one of the following signals:
an indicator signal si(t);
a control signal sc(t) for controlling the sound reproduction device reproducing SS_PLY the sound signal ss(t).

In particular, the management method SL_MNGT comprises:
controlling SL_CNT a variation of the sound level Δsl based on a variation of the parameter of the picked-up neural signal Δpₛₙ₍ₜ₎.

In particular, the direction of controlled variation of the sound level Δsl is at least one of the following directions:
a direction identical to the direction of variation of the parameter of the beta wave of the neural signal Δp_{β(t)};
a direction opposite the direction of variation of the parameter of the alpha wave of the neural signal Δp_{α(t)}.

In particular, the indicator signal si(t) is at least one of the following indicators:
a visual indicator;
an onomatopoeic acoustic indicator;
an audible alarm acoustic indicator;
an audio message acoustic indicator.

In particular, the management method SL_MNGT comprises one of the following steps:
replacing SUBST, in the signal s(t) to be reproduced, the sound signal ss(t) with an acoustic indicator signal si(t);
mixing MIX the acoustic indicator signal si(t) with the sound signal ss(t), the mixed sound signal ss′(t) constituting the signal s(t) to be reproduced.

In particular, the management method SL_MNGT comprises:
collecting SN_CL (not illustrated) a neural signal sn(t) picked up during listening, by a user U, to the reproduced sound signal sr(t).

In particular, collecting CN_CL the picked-up neural signal sn(t) comprises one of the following steps:
picking up SN_CPT a neural signal from a user U during listening, by the user U, to the reproduced sound signal sr(t);
receiving SN_RCV, from a neural sensor NCPT (not illustrated) or from a direct neural interface BCI, a neural signal sn(t) from a user U picked up during listening, by the user U, to the reproduced sound signal sr(t).

In particular, the management method SL_MNGT comprises:
extracting, from a picked-up neural signal sn(t), a neural wave o(t), in particular an alpha wave α(t) or a beta wave β(t).

In particular, the management method SL_MNGT comprises:
checking FT (vs) ? whether the value of a parameter of the picked-up neural signal crosses a threshold value vs.

In particular, the check FT (vs) ? determines whether the value of a parameter of a wave of the picked-up neural signal crosses the threshold value vs.

Crossing a threshold value is understood to mean for example:
either that the value of the parameter drops below the threshold value when the threshold value is a minimum value,
or that the value of the parameter rises above the threshold value when the threshold value is a maximum value,
more generally, that the value of the parameter or the absolute value of the parameter leaves a range of values bounded by at least one threshold value vs, for example [0, vs] or [vs, ∞[or [vs1, vs2], etc.

In particular, if the result of the check FT (vs) ? is positive, then the management method SL_MNGT comprises triggering generation GN_TRG.

In particular, triggering generation GN_TRG activates generation of a management signal SM_GN by way of a trigger signal trg.

It should be noted that triggering generation GN_TRG depends in particular on the user sound reproduction context c_{U}(t). Namely, the dependency of triggering generation GN_TRG is in particular one of the following dependencies:
the user context c_{U}(t) is the condition for activating generation of a management signal SM_GN by triggering generation GN_TRG (that is to say, for a given user context c_{U}(t), generation of a management signal SM_GN might not be activated even if the check FT(vs) ? is positive; or vice versa);
the trigger signal trg contains information relating to the user context c_{U}(t)
etc.

In particular, generation of a management signal SM GN comprises at least one of the following steps:
generating an indicator signal SI_GN;
generating a control signal SC_GN for controlling the sound reproduction device.

In particular, generation of an indicator signal SI_GN comprises at least one of the following steps:
determining SI_SLT an indicator signal si(t) based on the picked-up neural signal sn(t);
determining MSSG_SLT a message mssg based on the picked-up neural signal sn(t) and voice-synthesizing the determined message SYNT, the resulting indicator signal si(t) consisting of the determined voice-synthesized message.

Determining an indicator signal SI_SLT comprises in particular searching (not illustrated) for an indicator signal si(t) based on the picked-up neural signal sn(t), in particular in a base of indicator signals, on the Internet, etc.

In addition or as an alternative to searching for indicator signals, determining an indicator signal SI_SLT is done by creating and/or modifying indicator signals (not illustrated), in particular based on learning. The creation and/or modification of indicator signals is carried out using a neural network, an artificial intelligence device, etc.

Determining a message MSSG_SLT comprises in particular searching (not illustrated) for a message mssg based on the picked-up neural signal sn(t), in particular in a base of messages, on the Internet, etc.

In addition or as an alternative to searching for messages, determining a message MSSG_SLT is done by creating and/or modifying messages (not illustrated), in particular based on learning. The creation and/or modification of messages is carried out using a neural network, an artificial intelligence device, etc.

Generating a control signal SC_GN comprises in particular determining a control signal sc(t). In particular, determining the control signal sc(t) comprises in particular searching (not illustrated) for a control signal sc(t) based on the picked-up neural signal sn(t), in particular in a base of indicator signals, on the Internet, etc.

In addition or as an alternative to searching for control signals, generating a control signal SC_GN comprises creating and/or modifying control signals (not illustrated), in particular based on learning. The creation and/or modification of control signals is carried out using a neural network, an artificial intelligence device, etc.

In particular, the management method SL_MNGT comprises transmitting the management signal SM_EM (not illustrated), SI_TRT, SC_CNT, the management signal sm(t) comprising at least one indicator signal si(t) and/or a control signal sc(t) thus generated, such that, respectively, the indicator signal si(t) is reproduced by the reproduction SS_PLY, mixed or not into the reproduced sound signal sr(t), and/or the control signal controls the sound level of the reproduction SS_PLY of the reproduced sound signal sr(t).

In particular, the management method SL_MNGT comprises processing SI_TRT the sound signal s(t) to be reproduced based on the generated indicator signal si(t). In particular, the processing SI_TRT comprises one of the following steps:
replacing SUBST, in the signal s(t) to be reproduced, the sound signal ss(t) with an acoustic indicator signal si(t);
mixing MIX the acoustic indicator signal si(t) with the sound signal ss(t), the mixed sound signal ss′(t) constituting the signal s(t) to be reproduced.

In particular, the processing SI_TRT comprises switching CMT, providing the signal s(t) to be reproduced and the generated acoustic indicator signal si(t) to the replacement SUBST or to the mixing MIX based in particular on a prior setting of the processing SI_TRT, in particular made by the user, by parental control, etc. depending on whether or not they prefer to continue listening to the sound signal ss(t) during the reproduction of a sound level indicator signal.

In particular, the processing SI_TRT comprises transmitting SI_EM (not illustrated) the indicator signal with a view to having it reproduced by the reproduction SS_PLY in a signal s(t) to be reproduced comprising either the indicator signal si(t) alone provided by the substitution SUBST or the indicator signal si(t) mixed with the sound signal ss(t) provided by the mixing MIX.

As an alternative (not illustrated), transmitting the management signal SM_EM transmits an indicator signal si(t) generated by the management method SL_MNGT to processing SI_TRT external to the management method SL_MNGT.

In particular, the management method SL_MNGT comprises controlling the variation of the sound level SL_CNT based on the generated control signal sc(t). In particular, controlling the variation of the sound level SL_CNT comprises transmitting SC_EM (not illustrated) the control signal sc(t), for example in the form of transmitting the sound level sl′ controlled based on the control signal sc(t).

As an alternative (not illustrated), transmitting the management signal SM_EM transmits a control signal sc(t) generated by the management method SL_MNGT to controlling the variation of the sound level SL_CNT external to the management method SL_MNGT.

One particular embodiment of the management method is a program comprising program code instructions for executing the steps of the method for managing the reproduction sound level SL_MNGT when said program is executed by a processor.

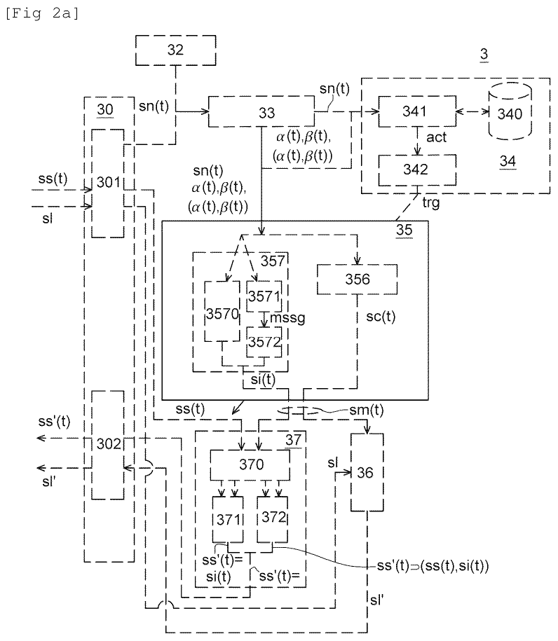

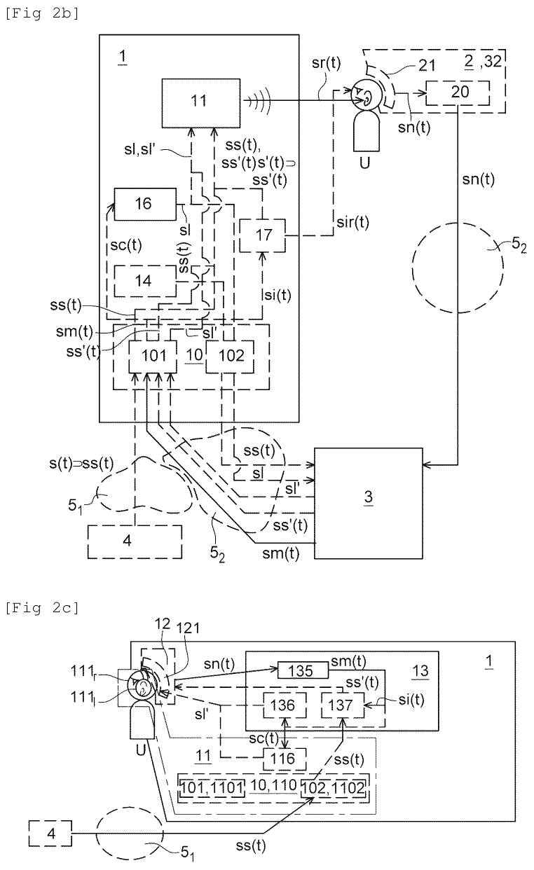

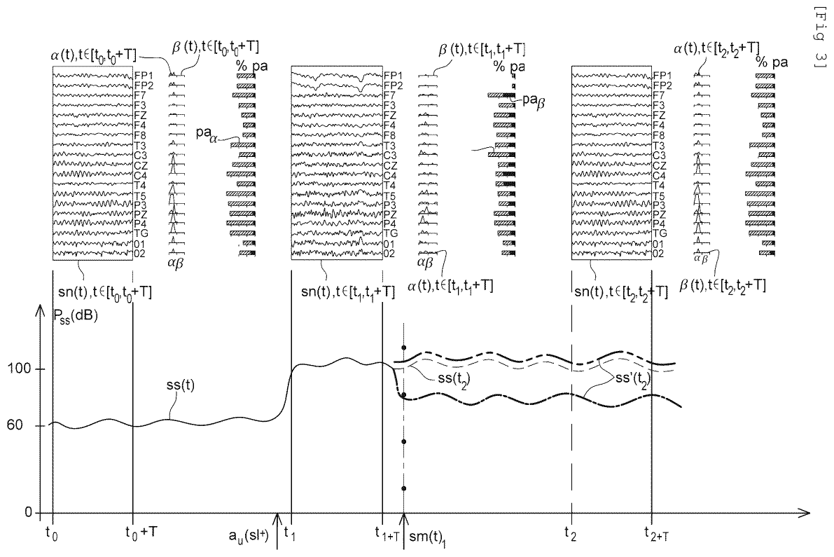

FIG. 2a illustrates a simplified diagram of a manager according to the invention.

The sound level manager 3 is capable of managing the reproduction sound level of a sound signal during reproduction of the sound signal. The manager 3 comprises:
a generator 35 for generating a management signal sm(t) for managing the sound level, also called management signal, of a sound reproduction of a sound signal s(t) as a function of at least one parameter pₛₙ₍ₜ₎ of a picked-up neural signal sn(t), the neural signal being picked up on the basis of listening to the reproduced sound signal sr(t).

In particular, the manager 3 comprises a transmitter 30 capable of transmitting and/or receiving signals, including in particular:
receiving the signal s(t) to be reproduced comprising the sound signal ss(t);
receiving a picked-up neural signal sn(t);
transmitting a management signal sm(t); etc.

In particular, the manager 3 comprises a receiver 301 capable of receiving signals, including in particular:
receiving the signal s(t) to be reproduced comprising the sound signal ss(t);
receiving a picked-up neural signal sn(t); etc.

In particular, the manager 3 comprises a transmitter 302 capable of transmitting signals, including in particular transmitting a management signal sm(t).

The transmitter 30 comprises for example the receiver 301 and/or the transmitter 302.

In particular, the manager 3 comprises:
a collector 32 for collecting neural signals sn(t) picked up during listening, by a user U, to the reproduced sound signal sr(t).

The collector 32 for collecting picked-up neural signals sn(t) consists in particular of at least one of the following devices:
a sensor for picking up neural signals from a user U during listening, by the user U, to the reproduced sound signal sr(t);
a receiver for receiving picked-up neural signals sn(t) (in particular the receiver 301 or the receiver of the transmitter 30). The neural signal sn(t) from a user U received by the collector 32 being picked up during listening, by the user U, to the reproduced sound signal sr(t). The receiver for receiving picked-up neural signals sn(t) is in particular capable of receiving picked-up neural signals from a neural sensor (not illustrated) or from a direct neural interface BCI.

In particular, the manager 3 comprises:
an extractor 33 for extracting neural waves o(t), in particular an alpha wave α(t) or a beta wave β(t), from a neural signal sn(t) picked up during listening, by the user U, to the reproduced sound signal sr(t). In particular, the extractor 33 extracts a neural wave from a picked-up neural signal provided by the collector 32, for example by a sensor or a receiver for receiving previously picked-up neural signals.

In particular, the manager 3 comprises:
an activator 34 for activating the management signal generator 35 as soon as the value of the parameter of the picked-up neural signal sn(t) crosses a predetermined threshold value vs.

In particular, the threshold value vs is one of the following values:
a maximum alert value vaₘₐₓ;
a maximum tolerance value vtₘₐₓ;
a minimum value vsₘᵢₙᵢ;
etc.

In particular, the manager 3 comprises:
a checker 341 for checking the value of a parameter of the picked-up neural signal in relation to a threshold value vs.

In particular, the checker 341 determines whether the value of a parameter of a wave of the picked-up neural signal crosses the threshold value vs. The threshold value vs is in particular a value read from a threshold value base 340. For example, the threshold value vs depends on the user U and/or the user sound reproduction context c_{U}(t).

In particular, if the result provided by the checker 341 is positive, then the checker 341 commands act the trigger 342 to trigger trg the management signal generator 35.

In particular, the trigger 342 activates the management signal generator 35 by way of a trigger signal trg.

In particular, the activator 34 for activating the management signal generator 35 comprises one or more of the following devices:
the checker 341 for checking the value of a parameter of the picked-up neural signal;
the threshold value base 340;
the trigger 342.

In particular, the management signal generator 35 comprises at least one of the following devices:
an indicator signal generator 357;
a control signal generator 356 for generating a control signal for the sound reproduction device 1, 11.

In particular, the indicator signal generator 357 comprises at least one of the following devices:
a first analyzer 3570 capable of determining an indicator signal si(t) based on the picked-up neural signal sn(t);
a second analyzer 3571 capable of determining a message mssg based on the picked-up neural signal sn(t), the second analyzer 3571 being coupled to a voice synthesizer 3572 capable of voice-synthesizing the determined message, the resulting indicator signal si(t) consisting of the determined voice-synthesized message.

The first analyzer 3570 capable of determining an indicator signal comprises in particular a search engine (not illustrated) for searching for an indicator signal si(t) based on the picked-up neural signal sn(t), in particular in a base of indicator signals, on the Internet, etc.

In addition or as an alternative to the indicator signal search engine, the first analyzer 3570 capable of determining an indicator signal comprises an indicator signal creator and/or modifier (not illustrated), in particular based on learning. The indicator signal creator and/or modifier comprises in particular a neural network, an artificial intelligence device, etc.

The second analyzer 3571 capable of determining a message mssg comprises in particular a search engine (not illustrated) for searching for a message mssg based on the picked-up neural signal sn(t), in particular in a base of messages, on the Internet, etc.

In addition or as an alternative to the message search engine, the second analyzer 3571 capable of determining a message mssg comprises a message creator and/or modifier (not illustrated), in particular based on learning. The message creator and/or modifier comprises in particular a neural network, an artificial intelligence device, etc.

The control signal generator 356 comprises in particular a third analyzer (not illustrated) capable of determining a control signal sc(t). In particular, the third analyzer capable of determining the control signal sc(t) comprises in particular a search engine (not illustrated) for searching for a control signal sc(t) based on the picked-up neural signal sn(t), in particular in a base of indicator signals, on the Internet, etc.

In addition or as an alternative to the control signal search engine, the control signal generator 356 comprises a control signal creator and/or modifier (not illustrated), in particular based on learning. The control signal creator and/or modifier comprises in particular a neural network, an artificial intelligence device, etc.

In particular, the manager 3 comprises a transmitter 30, 302 for transmitting the management signal, the management signal sm(t) comprising at least one indicator signal si(t) and/or a control signal sc(t) thus generated, such that, respectively, the indicator signal si(t) is reproduced by the reproduction device 1, 11, mixed or not into the reproduced sound signal sr(t), and/or the control signal controls the sound level of the reproduction of the reproduced sound signal sr(t).

In particular, the manager 3 comprises a processor 37 for processing the sound signal s(t) to be reproduced based on the generated indicator signal si(t). In particular, the processing processor 37 comprises one of the following devices:
a replacement device 371 for replacing, in the signal s(t) to be reproduced, the sound signal ss(t) with an acoustic indicator signal si(t);
a mixer 372 for mixing the acoustic indicator signal si(t) with the sound signal ss(t), the mixed sound signal ss′(t) constituting the signal s(t) to be reproduced.

In particular, the processing processor 37 comprises a switch 370, providing the signal s(t) to be reproduced and the generated acoustic indicator signal si(t) to the replacement device 371 or to the mixer 372 based in particular on a prior setting of the processing implemented by the processing processor 37, in particular made by the user, by parental control, etc. depending on whether or not they prefer to continue listening to the sound signal ss(t) during the reproduction of a sound level indicator signal.

In particular, either the processing processor 37 (case not illustrated) or the manager 3 comprises a transmitter 30, 302 for transmitting the indicator signal with a view to having it reproduced by the reproduction device 1, 11 in a signal s(t) to be reproduced comprising either the indicator signal si(t) alone provided by the replacement device 371 or the indicator signal si(t) mixed with the sound signal ss(t) provided by the mixer 372.

As an alternative (not illustrated), the transmitter 30, 302 for transmitting the management signal transmits an indicator signal si(t) generated by the manager 3 to a processing processor (not illustrated) that is external to the manager 3.

In particular, the manager 3 comprises a controller 36 for controlling the variation of the sound level based on the generated control signal sc(t). In particular, either the controller 36 (case not illustrated) or the manager 3 comprises a transmitter 30, 302 for transmitting the control signal sc(t), for example in the form of transmitting of the sound level sl′ controlled based on the control signal sc(t).

As an alternative (not illustrated), the transmitter 30, 302 for transmitting the management signal transmits a control signal sc(t) generated by the manager 3 to a sound level variation controller (not illustrated) that is external to the manager 3.

For example, when the parameter of the neural signal picked up on the basis of listening to the reproduced sound signal indicates that listening to the sound signal may alter the user's auditory system in the shorter or longer term, the manager 3 generates a management signal comprising a sound level control signal by way of which it controls an internal sound level variation controller 36 or one external to the manager 3 such that the sound level is thus reduced.

FIG. 2b illustrates a simplified diagram of a sound reproduction device according to the invention.

The sound reproduction device 1 is capable of reproducing a signal s(t) to be reproduced comprising a sound signal ss(t). The reproduction device 1 comprises:
an actuator 16, 17 capable of being managed based on a management signal sm(t) for managing the sound level, also called management signal, of a sound reproduction of a sound signal as a function of at least one parameter pₛₙ₍ₜ₎ of a neural signal sn(t) picked up by a direct neural interface 2, 32 collocated with the sound reproduction device 1, the neural signal being picked up on the basis of listening to the reproduced sound signal sr(t).

In particular, the actuator 16, 17 comprises at least one of the following actuators:
a display 17 capable of being controlled based on the management signal;
a display 17 capable of reproducing a message contained in the management signal;
a sound level controller 16 capable of being controlled based on the management signal;
a switch 17 capable of replacing, in a signal to be reproduced, a sound signal with the management signal;
a mixer 17 capable of mixing the sound signal and the management signal, the mixed sound signal constituting the signal to be reproduced.

In particular, the direct neural interface 2, 32 comprises at least one sensor 21 for picking up neural signals sn(t) from a user U.

In particular, the direct neural interface 2, 32 is capable of providing the manager 3 with a neural signal picked up on the basis of listening, by the user U, to a reproduced sound signal sr(t). For example, when the direct neural interface 2 is external to the manager 3, the direct neural interface comprises in particular a transmitter 20 capable of transmitting the picked-up neural signal sn(t) to the manager 3 via in particular a second communication network 52. In another example, when the manager 3 comprises the direct neural interface 32, the direct neural interface 32 is connected to the management signal generator 35 directly (to which it provides the picked-up neural signal sn(t)) or indirectly, in particular via one or more of the following devices: the extractor 33, the activator 34, the checker 341, the trigger 342, etc. (the picked-up neural signal will then be provided to that one of the devices that is connected directly to the direct neural interface 32).

The manager 3 is a sound level manager 3 according to the invention, in particular such as the one illustrated in FIG. 2a. The sound level manager 3 is capable of managing the reproduction sound level sl of a sound signal ss(t) during reproduction of the sound signal. The manager 3 comprises a generator 35 (not illustrated in FIG. 2b) for generating a management signal sm(t) for managing a sound reproduction of a sound signal s(t) as a function of at least one parameter pₛₙ₍ₜ₎ of a neural signal sn(t) picked up during listening to the reproduced sound signal sr(t).

In particular, the manager 3 is capable of providing the reproduction device 1 with one of the following signals:
the management signal sm(t) generated based in particular on the neural signal sn(t) picked up during the sound reproduction of the sound signal ss(t), and possibly one or more of the following signals: the sound signal ss(t), the sound level sl used by the reproduced signal sr(t);
a sound level sl′ controlled based on the management signal sm(t), in particular based on a control signal sc(t) of the management signal sm(t) ;
a sound signal ss′(t) modified based on the management signal sm(t), in particular based on an indicator signal si(t) of the management signal sm(t); etc.

The manager 3 provides the signals to the reproduction device in particular via the second communication network 5₂.

With the reproduction device 1, the manager 3 and, where applicable, the external direct neural interface 2 being collocated, the second communication network 5₂ is a local area communication network.

In particular, a sound signal provider 4, 14 provides the signal s(t) to be reproduced, comprising a sound signal ss(t).

In a first embodiment, the sound signal provider 4 is external to the reproduction device 1 and provides the signal s(t) to be reproduced in particular via a first communication network 5₁.

If the sound signal provider 4 is collocated with the reproduction device 1, then the first communication network 5₁ is also a local area communication network. In this case, the first communication network 5₁ and the second communication network 5₂ are then either one and the same communication network (that is to say identical communication networks) or separate communication networks (for example, the first communication network 5₁ is a Wi-Fi™ network and the second communication network 5₂ is a Bluetooth™ network).

If the sound signal provider 4 is remote from the reproduction device 1, then the first communication network 5₁ is a remote communication network. In this case, the first communication network 5₁ and the second communication network 5₂ are then separate communication networks (for example, the first communication network 5₁ is a wired or non-wired Internet network—in particular a fiber or 5G network, etc.—and the second communication network 5₂ is a local area network—a Bluetooth™ network for example).

In a second embodiment, the reproduction device 1 comprises the sound signal provider 14, which provides the signal s(t) to be reproduced in particular to the sound reproducer 11, such as a sound card, a loudspeaker, etc., directly or indirectly.

When the actuator 17 capable of being managed based on an indicator signal si(t) of the management signal sm(t) generated by the manager 3, also indication actuator 17, comprises a replacement device and/or a mixer, the sound signal provider 4, 14 provides the signal s(t) to be reproduced to the indication actuator 17, which, respectively, replaces the sound signal ss(t) in the provided signal s(t) to be reproduced with the indicator signal si (t) or mixes the sound signal ss(t) in the provided signal s(t) to be reproduced with the indicator signal si(t). The indication actuator 17 then provides the reproducer 11, instead of with the signal s(t) to be reproduced provided by the provider 4, 14, with a modified signal to be reproduced comprising a substituted or mixed sound signal ss′(t) comprising the indicator signal si(t).

When the indicator actuator 17 comprises an indicator signal si(t) display, the user U reads, in particular in the case of an indicator signal si(t) comprising a text message, or perceives, in particular in the case of an indicator signal activating at least one luminous indicator, the reproduced indicator signal sir(t).

When the actuator 16 capable of being managed based on a control signal sc(t) of the management signal sm(t) generated by the manager 3, also called control actuator 16, comprises a sound level controller, the sound signal provider 4, 14 provides the signal s(t) to be reproduced to the control actuator 16, which modifies the sound level sl of the sound signal ss(t) of the provided signal s(t) to be reproduced based on the control signal sc(t). The control actuator 16 then provides the reproducer 11, instead of with the sound level sl commanded by the user U, with the modified sound level sl′.

In particular, the reproduction device 1 comprises a control interface (not illustrated) capable of receiving a sound level command sl from the user U, prior to the implementation of the control actuator 16.

The reproduction device 1 is thus capable of reproducing:
in particular by way of the reproducer 11, a sound signal ss(t) or even a modified sound signal ss′(t) comprising an indicator signal si(t) of a management signal sm(t) generated by the manager 3 with a sound level sl, for example controlled by a user interface (not illustrated), such as the abovementioned control interface, or even a sound level sl′ modified based on a control signal sc(t) of a management signal sm(t) generated by the manager 3; and/or
in particular by way of a display 17, an indicator signal si(t) of a management signal sm(t) generated by the manager 3 or a visual indicator based on controlling of the display by the indicator signal si(t).

FIG. 2c illustrates a simplified diagram of an audio headset according to the invention.

The audio headset 1 comprises:
a sound level manager 13,
a sound reproduction device 11 comprising at least one sound reproducer 111ᵣ, 111₁, such as earphones, and
a direct neural interface 12 capable of picking up the neural signal on the basis of listening to the reproduced sound signal.

The manager 13 is a sound level manager according to the invention, in particular such as the manager 3 illustrated in FIG. 2a.

The sound reproduction device 11 is capable of reproducing a signal s(t) to be reproduced comprising a sound signal ss(t), ss′(t) with a sound level sl, sl′.

In particular, a sound signal provider 4, 14 (not illustrated in FIG. 2c) provides a signal s(t) to be reproduced comprising a sound signal ss(t).

In a first embodiment, the sound signal provider 4 is external to the reproduction device 11, or even external to the audio headset 1, and provides the signal s(t) to be reproduced in particular via a first communication network 5₁.

In a second embodiment, the reproduction device 11 comprises the sound signal provider 14 (not illustrated in FIG. 2c), which provides the signal s(t) to be reproduced in particular to the sound reproducer 11, such as a sound card, a loudspeaker, etc., directly or indirectly. In particular, the audio headset 1 comprises the sound signal provider 14.

In particular, the reproduction device 11 comprises a control interface (not illustrated) capable of receiving a sound level command sl from the user U for controlling the reproduction sound level of the signal sr(t) reproduced by the reproducer 111ᵣ, 111₁.

In particular, the audio headset 1 and/or the reproduction device 11 comprises a transmitter 10, 110 capable of transmitting and/or receiving signals, including in particular a sound signal ss (t), a signal s (t) to be reproduced comprising a sound signal, a sound level command, etc. In particular, the audio headset 1 and/or the reproduction device 11, or even the transmitter 10, 110, comprises one or more of the following devices:
a signal transmitter 101, 1101 capable of transmitting at least one signal, in particular an indicator signal si(t) of a management signal sm(t) to a communication terminal, in particular a communication terminal of a third party (for example a parent's cell phone);
a signal receiver 102, 1102 capable of receiving at least one signal, in particular a sound signal ss(t) or a signal s(t) to be reproduced comprising a sound signal from a sound signal provider, a sound volume command from a control interface external to the audio headset, etc.

The reproduction device 11 of the audio headset 1 is thus capable of reproducing a signal s(t) to be reproduced comprising a sound signal ss(t) provided by a sound signal provider 4, 14 (such as an audio file player for playing audio files from an audio content base—not illustrated—in particular a USB stick, a CD, an SD card, etc., an Internet provider of streaming audio content, etc.) with a sound level sl.

The neural interface 12 is capable of picking up a neural signal sn(t) from the user U while the user U is listening to a reproduced sound signal sr(t) comprising the sound signal ss(t) with a sound level sl. In particular, the direct neural interface 12 comprises at least one sensor 121 for picking up neural signals sn(t) from a user U.

In particular, the direct neural interface 12 is capable of providing the manager 13 with the neural signal picked up during listening, by the user U, to a reproduced sound signal sr (t). With the audio headset 1 comprising both the direct neural interface 12 and the manager 13, the direct neural interface 12 is connected directly or indirectly to the management signal generator 135 of the manager 13.

The remainder of the description of FIG. 2b envisages a number of embodiments that may be implemented alone or in combination with one or more others.

The sound level manager 13 is capable of managing the reproduction sound level sl of a sound signal ss (t) during reproduction of the sound signal. The manager 13 comprises a generator 135 for generating a management signal sm(t) for managing a sound reproduction of a sound signal s(t) as a function of at least one parameter pₛₙ₍ₜ₎ of a neural signal sn(t) picked up during listening to the reproduced sound signal sr(t).

In particular, the manager 13 is capable of providing the reproduction device 11 with one of the following signals:
the management signal sm(t) generated based in particular on the neural signal sn(t) picked up during the sound reproduction of the sound signal ss(t), and possibly one or more of the following signals: the sound signal ss(t), the sound level sl used by the reproduced signal sr(t);
a sound level sl′ controlled based on the management signal sm(t), in particular based on a control signal sc(t) of the management signal sm(t) ;
a sound signal ss′(t) modified based on the management signal sm(t), in particular based on an indicator signal si(t) of the management signal sm(t); etc.

In a first particular embodiment, the reproduction device 11 comprises:
an actuator 116, 117 capable of being managed based on a management signal sm(t) for managing a sound reproduction of a sound signal as a function of at least one parameter pₛₙ₍ₜ₎ of a neural signal sn(t) picked up, during listening to the reproduced sound signal sr(t), by a direct neural interface 12.

In particular, the actuator 116, 117 comprises at least one of the following actuators:
a display 117 capable of being controlled based on the management signal;
a display 117 capable of reproducing a message contained in the management signal;
a sound level controller 116 capable of being controlled based on the management signal;
a switch 117 capable of replacing, in a signal to be reproduced, a sound signal with the management signal;
a mixer 117 capable of mixing the sound signal and the management signal, the mixed sound signal constituting the signal to be reproduced.

For example, the audio headset 1 comprises at least one set of glasses, a screen of which constitutes a display 117, the screen being in particular an augmented-reality screen. A display 117 consists in particular of one or more diodes, in particular LEDs, placed on a casing of an earphone 111ᵣ, 111₁ of the audio headset 1. The diode is in particular selected so as to be visible to the user wearing the audio headset 1 when it is switched on.

When the actuator 117 capable of being managed based on an indicator signal si(t) of the management signal sm(t) generated by the manager 13, also indication actuator 117, comprises a replacement device and/or a mixer, the sound signal provider 4, 14 provides the signal s(t) to be reproduced to the indication actuator 117, which, respectively, replaces the sound signal ss(t) in the provided signal s(t) to be reproduced with the indicator signal si(t) or mixes the sound signal ss(t) in the provided signal s(t) to be reproduced with the indicator signal si(t). The indication actuator 117 then provides the one or more reproducers 111ᵣ, 111₁, instead of with the signal s(t) to be reproduced provided by the provider 4, 14, with a modified signal to be reproduced comprising a substituted or mixed sound signal ss′(t) comprising the indicator signal si(t).

When the indicator actuator 117 comprises an indicator signal si(t) display, the user U reads, in particular in the case of an indicator signal si(t) comprising a text message, or perceives, in particular in the case of an indicator signal activating at least one luminous indicator, the reproduced indicator signal sir(t).

When the actuator 116 capable of being managed based on a control signal sc(t) of the management signal sm(t) generated by the manager 3, also called control actuator 116, comprises a sound level controller, the sound signal provider 4, 14 provides the signal s(t) to be reproduced to the control actuator 116, which modifies the sound level sl of the sound signal ss(t) of the provided signal s(t) to be reproduced based on the control signal sc(t). The control actuator 116 then provides the one or more reproducers 111ᵣ, 111₁, instead of with the sound level sl commanded by the user U, with the modified sound level sl′.

In a second particular embodiment, the manager 3 comprises at least one of the following devices:
a controller 36 for controlling the variation of the sound level based on the generated control signal sc(t). In particular, either the controller 136 (case not illustrated) or the manager 3 comprises a transmitter 30, 302 for transmitting the control signal sc(t), for example in the form of transmitting of the sound level sl′ controlled based on the control signal sc(t).
a processor 137 for processing the sound signal s(t) to be reproduced based on the generated indicator signal si(t). In particular, the processing processor 37 comprises one of the following devices:
a replacement device 371 (not illustrated in FIG. 2c) for replacing, in the signal s(t) to be reproduced, the sound signal ss(t) with an acoustic indicator signal si(t);
a mixer 372 (not illustrated in FIG. 2c) for mixing the acoustic indicator signal si (t) with the sound signal ss(t), the mixed sound signal ss′(t) constituting the signal s(t) to be reproduced.

The reproduction device 11 is thus capable of reproducing:
in particular by way of the one or more reproducers 111ᵣ, 111₁, a sound signal ss(t) or even a modified sound signal ss′(t) comprising an indicator signal si(t) of a management signal sm(t) generated by the manager 13 with a sound level sl, for example controlled by a user interface (not illustrated), such as the abovementioned control interface, or even a sound level sl′ modified based on a control signal sc(t) of a management signal sm t) generated by the manager 13; and/or
in particular by way of a display 117, an indicator signal si(t) of a management signal sm(t) generated by the manager 13 or a visual indicator based on controlling of the display by the indicator signal si(t).

FIG. 3 illustrates a simplified diagram of the picked-up neural signals and the reproduced sound signals according to the invention.

At a first time corresponding to the time t₀, the user U is listening to a sound signal ss(t₀) with a sound level sl(t₀) measured, in FIG. 3, by an acoustic power Pss in decibels (dB) of around 60 dB. The picked-up neural signals sn(t₀) are then illustrated at the top, and may be broken down into neural waves o(t), in particular an alpha wave α(t) and a beta wave β(t) for a period of time T starting from this time to: [t₀, t₀+T[ for which the absolute power percentage % pa is given in FIG. 3, for example pa_{α}.

It is noted that, at the time to, the neural signal from the user has an alpha wave the absolute power of which is high and a beta wave the absolute power of which is low or even non-existent. The manager 3 will then not trigger generation of a management signal because the alpha and/or beta waves have a parameter, for example an absolute power, with an appropriate value with respect to a threshold value (because it is higher than this value for the alpha wave and/or lower than this value for the beta wave in this case). Indeed, the neural signal shows that the user U is in an alert state, since their alpha wave has a high absolute power, and in a focused state, since their beta wave has a low absolute power.

At the time t1, the reproduction sound level of the sound signal sl(t₁) is increased in particular upon the command of the user U. The measured acoustic power Pss then changes to at least 100 dB. The picked-up neural signals sn(t₁) are then illustrated at the top, and may be broken down into neural waves o(t), in particular an alpha wave α(t) and a beta wave β(t) for a period of time I starting from this time t₁: [t₁, t₁+T[ for which the absolute power percentage % pa is given in FIG. 3, for example pa_{β}.

It is noted that, at the time t1, the neural signal from the user varied: the absolute power of the alpha wave decreased and the absolute power of the beta wave greatly increased. The manager 3 then triggers the generation of a management signal sm(t) because the alpha and/or beta waves have a parameter, for example an absolute power, with an inappropriate value with respect to a threshold value (because it is lower than this value for the alpha wave and/or higher than this value for the beta wave in this case). Indeed, the neural signal shows that the user U has changed to a stressed state since their alpha wave has an absolute power that has decreased, and in an anxious state since their beta wave has an absolute power that has greatly increased.

In the example of FIG. 3, the management signal sm(t₁) generated by the sound level management according to the invention comprises at least one of the following signals:
a sound level control signal sc(t₁) used by a sound level controller 36, 16 to modify the sound level sl(t₁) to a modified, lower sound level sl′ (t₁). Thus, following this modification of the sound level sl′ (t₁), the measured acoustic power Pss returns to a lower level (dot-and-dash line);
an indicator signal si(t₁) comprising for example a voiced message indicating that the sound level is too high and that it is desirable to lower it, or even that the sound level is dangerous and that it should be lowered immediately.

Then, at a time t2 subsequent to this management of the sound level by the invention, respectively:
the measured acoustic power is approximately 70 dB; and/or
the reproduced sound signal is a modified sound signal ss′ (t₂) in which an indicator signal si of the management signal sm(t₁) generated by the sound level manager will have been either mixed or substituted with the sound signal ss(t₂) (dotted line).

The double-dot-and-dash line shows the modified sound signal ss′ (t₂) for which the sound level sl(t₂) will not have been modified, leaving the user the option to act or not on the sound level sl(t₂) themselves.

The invention proposes to base itself on the fact that it is possible to find, in EEG signals, indicators of the sound level, in particular of the discomfort caused by an excessively loud sound level, a contrario, of the comfort provided.

In particular, the invention is based on the impact of the sound level on alpha waves (8-12 Hz) and beta waves (13-30 Hz). In particular, alpha waves are relevant as an indicator of stress, and beta waves, for their part, are indicative of rapid brain activity or a disturbed situation of the brain. Thus, at a low or comfortable sound level, alpha waves have a high power and beta waves have a low power. This combination reflects a state of relaxation in the user and signifies that the sound level is suitable. On the contrary, when subjects are exposed to an excessively high sound level, the power of the beta waves increases, thereby indicating that the user is in a disturbed state. At the same time, the decrease in power of alpha waves shows that subjects are tense.

The invention therefore proposes to monitor neural signals, in particular alpha and beta waves, in order to automatically determine whether the user is subjected to discomfort due to excessively loud listening levels, whether or not they are aware of this. In the event that the level is too loud, there are a number of approaches. It is then possible to decrease the sound level automatically, to mute the sound, and/or to warn the user.

Similarly, the management method and/or the sound level manager according to the invention is capable of monitoring alpha and beta waves in order to determine whether the listening level is too low. Optionally, depending on a choice (setting) made by the user, it will then be possible to automatically increase the sound level or else to suggest to the user to increase the sound level.

The invention thus makes it possible to preserve the safety and/or health of people listening to music on a headset. Adjusting the level automatically makes it possible to prevent degradation of users' auditory system, in the case of excessively loud listening. In the case of an excessively low sound level, this solution makes it possible to automate comfortable adjustment of the sound level.

The invention also targets a medium. The information medium may be any entity or device capable of storing the program. For example, the medium may comprise a storage means, such as a ROM, for example a CD-ROM or a microelectronic circuit ROM, or else a magnetic recording means, for example a floppy disk or a hard disk.

On the other hand, the information medium may be a transmissible medium such as an electrical or optical signal that may be routed via an electrical or optical cable, by radio or by other means. The program according to the invention may in particular be downloaded from a network, in particular the Internet.

As an alternative, the information medium may be an integrated circuit into which the program is incorporated, the circuit being designed to execute or to be used in the execution of the method in question.

In another implementation, the invention is implemented by way of software components and/or hardware components. With this in mind, the term module may correspond both to a software component and to a hardware component. A software component corresponds to one or more computer programs, one or more subroutines of a program or, more generally, to any element of a program or of software that is able to implement a function or a set of functions according to the above description. A hardware component corresponds to any element of a hardware assembly that is able to implement a function or a set of functions.

Although the present disclosure has been described with reference to one or more examples, workers skilled in the art will recognize that changes may be made in form and detail without departing from the scope of the disclosure and/or the appended claims.

1. A management method implemented by a managing device and comprising:
managing a sound level during a sound reproduction of a sound signal, the managing comprising:
generating a management signal for managing the sound level of the sound reproduction of the sound signal as a function of at least one parameter of a picked-up neural signal, the neural signal being picked up on the basis of listening to the sound reproduction of the sound signal.

2. The management method as claimed in claim 1, the management method comprising:
triggering the generating as soon as a value of the parameter of the picked-up neural signal crosses a predetermined threshold value.

3. The management method as claimed in claim 2, wherein the threshold value is one of the following values:
a maximum alert value;
a maximum tolerance value;
a minimum value.

4. The management method as claimed in claim 3, wherein triggering the generating depends on a user sound reproduction context.

5. The management method as claimed in claim 1, wherein the at least one parameter of the neural signal comprises at least one of the following parameters:
a parameter of a beta wave of the neural signal;
a parameter of an alpha wave of the neural signal;
an absolute power of a wave of the neural signal.

6. The management method as claimed in claim 1, wherein the management signal comprises at least one of the following signals:
an indicator signal;
a control signal for controlling a sound reproduction device reproducing the sound signal.

7. The management method as claimed in claim 1, the management method comprising:
controlling a variation of the sound level based on a variation of the parameter of the picked-up neural signal.

8. The management method as claimed in claim 7, wherein the at least one parameter of the neural signal comprises at least one of a parameter of a beta wave of the neural signal or a parameter of an alpha wave of the neural signal, and wherein a direction of the controlled variation of the sound level is at least one of the following directions:
a direction identical to a direction of variation of the parameter of the beta wave of the neural signal;
a direction opposite a direction of variation of the parameter of the alpha wave of the neural signal.

9. The management method as claimed in claim 6, wherein the indicator signal is at least one of the following indicators:
a visual indicator;
an onomatopoeia acoustic indicator;
an audible alarm acoustic indicator;
an audio message acoustic indicator.

10. The management method as claimed in claim 9, the management method comprising one of:
replacing, in the sound signal to be reproduced, the sound signal with an acoustic indicator signal;
mixing the acoustic indicator signal with the sound signal, the mixed sound signal constituting the signal to be reproduced.

11. A non-transitory computer readable medium comprising a program stored thereon comprising program code instructions for executing the management method as claimed in claim 1 when said program is executed by a processor.

12. A managing device comprising:
at least one processor; and
at least one non-transitory computer readable medium comprising program code instructions stored thereon which when executed by the at least one processor configure the managing device to manage a sound level during a sound reproduction of a sound signal, the managing comprising:
generating a management signal for managing the sound level of the sound reproduction of the sound signal as a function of at least one parameter of a picked-up neural signal, the neural signal being picked up on the basis of listening to the sound reproduction of the sound signal.

13. A sound reproduction device capable of reproducing a signal to be reproduced comprising a sound signal, the reproduction device comprising:
an actuator capable of being managed based on a management signal for managing a sound level of a sound reproduction of the sound signal as a function of at least one parameter of a picked-up neural signal, the neural signal being picked up on the basis of listening to the sound reproduction of the sound signal by a direct neural interface collocated with the sound reproduction device.

14. The sound reproduction device as claimed in claim 13, wherein the actuator comprises at least one of the following actuators:
a display controlled based on the sound level management signal;
a display controlled to reproduce a message contained in the sound level management signal;
a sound level controller controlled based on the sound level management signal;
a switch which replaces, in a signal to be reproduced, a sound signal with the sound level management signal;
a mixer which mixes the sound signal and the sound level management signal, the mixed sound signal constituting the signal to be reproduced.

15. An audio headset comprising:
managing device as claimed in claim 12;
a sound reproduction device connected to the managing device and capable of producing the sound reproduction of the sound signal and comprising an actuator which is connected to receive the management signal; and
a direct neural interface capable of picking up the neural signal on the basis of listening to the sound reproduction of the sound signal.

16. The management method as claimed in claim 1, further comprising:
receiving the sound signal and the neural signal by at least one receiver of the managing device; and
transmitting the management signal by at least one transmitter of the managing device.

17. The managing device as claimed in claim 12, further comprising:
at least one receiver for receiving the sound signal and the neural signal; and
at least one transmitter for transmitting the management signal.
